(19) United States
(12) Patent Application Publication
(10) Pub. No.: US 2013/0275384 A1
(43) Pub. Date: Oct. 17, 2013

(54) SYSTEM, METHOD, AND COMPUTER PROGRAM PRODUCT FOR DETERMINING WHETHER AN ELECTRONIC MAIL MESSAGE IS UNWANTED BASED ON PROCESSING IMAGES ASSOCIATED WITH A LINK IN THE ELECTRONIC MAIL MESSAGE

(71) Applicants: Arun Kumar Sivasubramanian, Tirupur (IN); Udhayakumar Lakshmi Narayanan, Thirubuvanam (IN)

(72) Inventors: Arun Kumar Sivasubramanian, Tirupur (IN); Udhayakumar Lakshmi Narayanan, Thirubuvanam (IN)

(21) Appl. No.: 12/195,101

(22) Filed: Aug. 20, 2008

(51) Int. Cl. G06F 17/30

(52) U.S. Cl. 707/664; 707/E17.044

(57) ABSTRACT

A system, method, and computer program product are provided for determining whether an electronic mail message is unwanted based on processing images associated with a link in the electronic mail message. In use, a link in an electronic mail message is identified. Additionally, at least one image is loading using the link. Further, the at least one image is loaded. Still yet, it is determined whether the electronic mail message is unwanted based on the processing.

### FIELD OF THE INVENTION

The present invention relates to processing unwanted messages, and more particularly to processing unwanted messages involving unwanted images.

### BACKGROUND

Traditionally, unwanted messages, such as unsolicited messages, have been processed by analyzing content of the messages. However, traditional message analysis techniques utilized for processing unwanted messages have exhibited various limitations. For example, unwanted messages have sometimes included links to legitimate websites (e.g. websites with wanted content) on which the unwanted content is stored, such that analyzing content of the message is in capable of allowing the message to be identified as unwanted.

There is thus a need for addressing these and/or other issues associated with the prior art.

### SUMMARY

A system, method, and computer program product are provided for determining whether an electronic mail message is unwanted based on processing images associated with a link in the electronic mail message. In use, a link in an electronic mail message is identified. Additionally, at least one image is loading using the link. Further, the at least one image is loaded. Still yet, it is determined whether the electronic mail message is unwanted based on the processing.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for determining whether an electronic mail message is unwanted based on processing images associated with a link in the electronic mail message, in accordance with one embodiment.

FIG. 4 shows a system for determining whether an electronic mail message is unwanted based on processing images associated with a link in the electronic mail message, in accordance with another embodiment.

FIG. 5 shows a method for identifying an electronic mail message as unwanted based on a determination of whether a uniform resource identifier (URI) link of the electronic mail message includes a known unwanted URI, in accordance with yet another embodiment.

FIG. 6 shows a method for processing images associated with a URI of an electronic mail message for determining whether the electronic mail message is unwanted, in accordance with still yet another embodiment.

### DETAILED DESCRIPTION

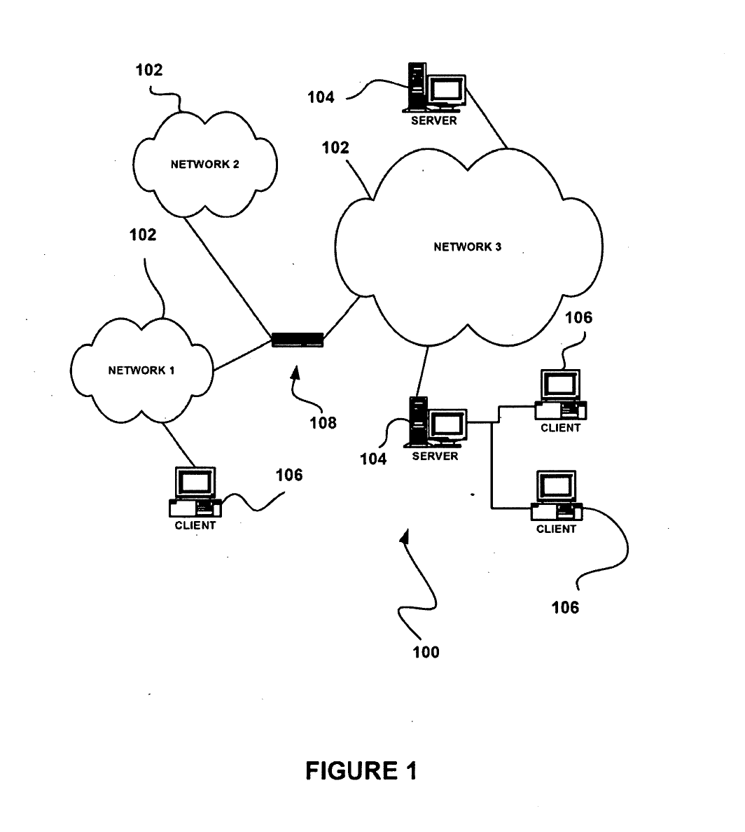

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

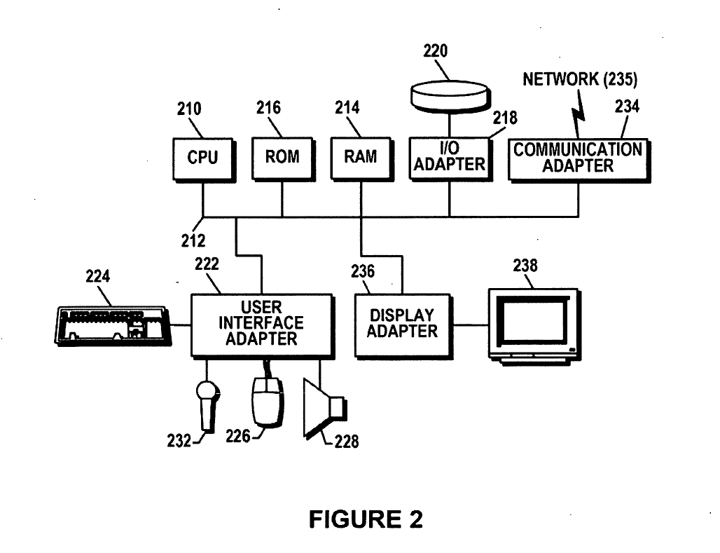

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written, using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof For that matter, any type of logic may be utilized which is capable of implementing the various functionality set forth herein.

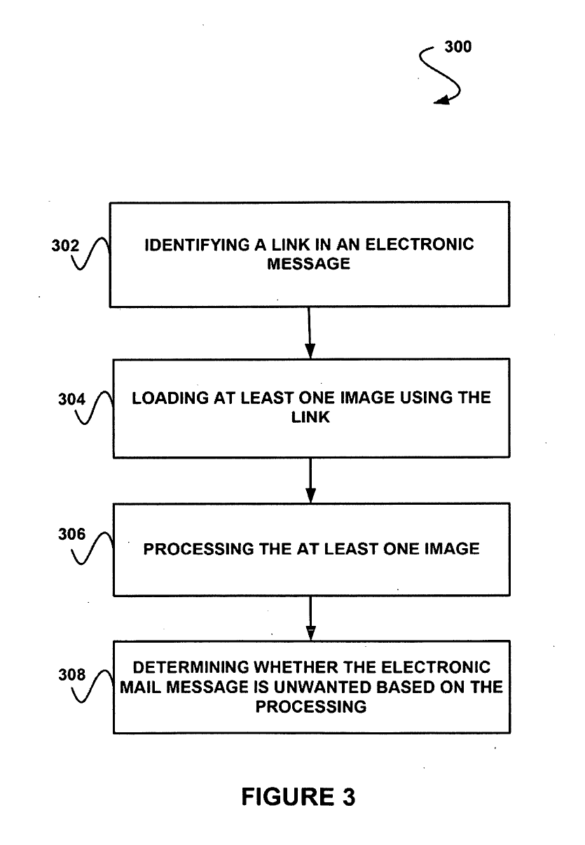

FIG. 3 shows a method 300 for determining whether an electronic mail message is unwanted based on processing images associated with a link in the electronic mail message, in accordance with one embodiment. As an option, the method 300 may be carried out in the context of the architecture and environment of FIGS. 1 and/or 2. Of course, however, the method 300 may be carried out in any desired environment.

As shown in operation 302, a link in an electronic mail (email) message is identified. With respect to the present description, the email message may include any mail message capable of being electronically communicated. For example, the email message may be capable of being communicated over a network utilizing an email messaging application (e.g. Microsoft® Outlook®, etc.).

Additionally, the link in the email message may include any data in the email message that links to other data (e.g. other data not necessarily included in the email message). In one embodiment, the other data may be accessed by selecting the link. For example, selection of the link may result in display of a webpage that includes the other data. Thus, as an option, the link may include a hyperlink. Just by way of example, the link may include a uniform resource identifier (URI), a uniform resource locator (URL), etc.

It should be noted that the link in the email message may be identified in any desired manner. In one embodiment, the email message may be analyzed for identifying the link. In another embodiment, the email message may be parsed for identifying the link. In yet another embodiment, it may be determined whether any content of the email message is of a format indicative of a link (e.g. includes predetermined characters indicative of the link, etc.), such that the link may be identified if it is determined that content of the email message is of a format indicative of a link.

Further, as shown in operation 304, at least one image is loaded using the link. Thus, in one embodiment, only a single image may be loaded. In another embodiment, a plurality of images may be loaded. For example, the link may be associated with (e.g. may link to) a single image or a plurality of images.

Additionally, the image may include any data that is representative of an image, picture, icon, photograph, etc. For example, the image may include a bitmap (BMP) image, a graphics interchange format (GIF) image, a Joint Photographic Experts Group (JPEG) image, and/or any other image of digital form.

In various embodiments, loading the image may include accessing the image, downloading the image, displaying the image, etc. In another embodiment, loading the image may include loading (e.g. downloading, etc.) a web page on which the image is located. To this end, the image may optionally be loaded utilizing a web browser.

Moreover, using the link to load the image may include selecting the link for loading the image, as an option. For example, upon selection of the link, the image may be automatically loaded. As another option, using the link to load the image may include inputting the link into a web browser for loading the image. For example, using the link to load the image may include loading the link. Of course, however, the image may be loaded in any desired manner.

Still yet, as shown in operation 306, the at least one image is processed. It should be noted that the image may be processed in any manner that, is capable of being utilized for determining whether the email message is unwanted, as described in more detail below. In one embodiment, the image may be processed by analyzing the image.

In another embodiment, the image may be processed by comparing the image to known unwanted images. Such known unwanted images may include images predetermined to be unwanted, such as unsolicited content, malware, etc. Just by way of example, information associated with the image may be identified (e.g. extracted from the image) and compared to information associated with known unwanted images. The information may include any characteristic capable of being associated with an image, such as a file name, a file signature, a file size, a length value, a pixel pattern, etc.

In yet another embodiment, the image may be processed by scoring the image. The scoring may be based on the information associated with the image, as described above. For example, each characteristic identified as being associated with the image may be associated with (e.g. assigned) a predetermined weight. In this way, a plurality of weights associated with characteristics of the image may optionally be aggregated to calculate a score for the image.

Furthermore, it is determined whether the email message is unwanted based on the processing, as shown in operation 308. Determining the email message to be unwanted may include determining the email message to be unsolicited, malware, etc. As an option, the email message may be determined to be unwanted if it is determined, based on the processing, that the image is unwanted (e.g. unsolicited, malware, etc.).

For example, in one embodiment, a result of the scoring of the image may be compared with a predefined threshold for determining whether the email message is unwanted. Such result of the scoring may include a score calculated for the image. Thus, if the result of the scoring meets the threshold, it may optionally be determined that the email message is unwanted. For example, if the result of the scoring meets the threshold it may be determined that the image is unwanted, and thus that the email message is unwanted.

To this end, it may be determined whether an electronic mail message is unwanted based on processing images associated with, a link in the email message. Processing images associated with the link in this manner may optionally allow the email message to be determined to be unwanted even when content actually included in the email message is not necessarily unwanted. Just by way of example, the link in the email message may be a link to a legitimate website, such as a website that is utilized for image sharing purposes. However, the image that is loaded using the link may be unwanted, thus resulting in the email message including the link being unwanted.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

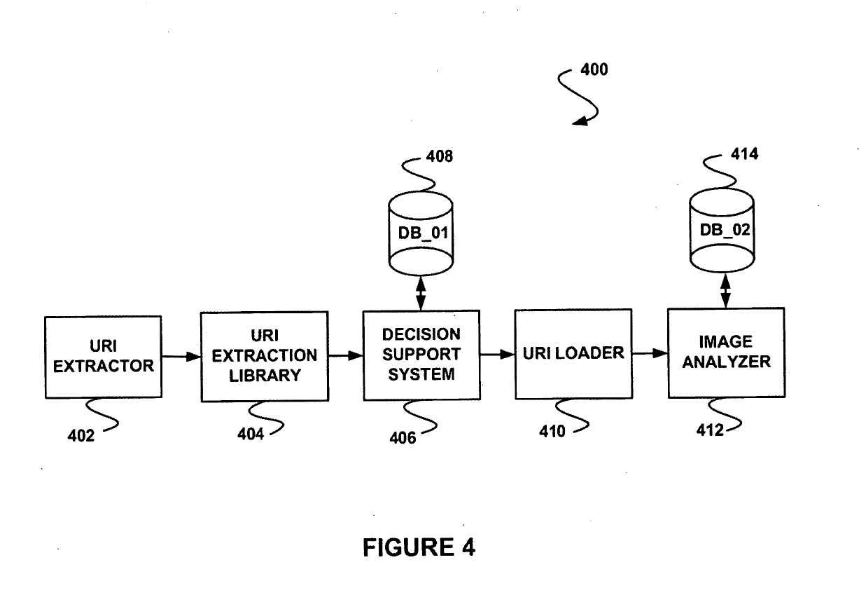

FIG. 4 shows a system 400 for determining whether an electronic mail message is unwanted based on processing images associated with a link in the electronic mail message, in accordance with another embodiment. As an option, the system 400 may be implemented in the context of the architecture and environment of FIGS. 1-3. Of course, however, the system 400 may be implemented in any desired environment. It should also be noted that the aforementioned definitions may apply during the present description.

As shown, the system includes a plurality of components 402-412. As an option, components 402, 404, 406, 410 and 412 may include code modules. For example, the code modules 402, 404, 406, 410 and 412, and optionally the databases 408 and 414 shown, may be included in an application utilized for determining whether an electronic mail message is unwanted based on processing images associated with a link in the electronic mail message.

In particular, the system 400 includes a URI extractor 402 in communication with a URI extraction library 404. In one embodiment, the URI extractor 402 may identify a URI in an email message. For example, the URI extractor 402 may extract any URI in the email message (e.g. by taking a copy of the URI, etc. from the email message).

As an option, the URI extractor 402 may identify the URI by identifying content of the email message that includes a predefined format. In one embodiment, predefined format may include a predefined pattern. Thus, content of the email message, such as raw text of the email message, may be searched for the predefined format. Such URI identification may involve hacks to manage URIs that cross line boundaries, as an option.

Table 1 shows one embodiment of a predefined format that may be utilized for identifying a URI in the email message. It should be noted that such predefined format is set forth for illustrative purposes only, and thus should not be construed as limiting in any manner.

TABLE 1

<protocol>://<domain>

Thus, with respect to Table 1, and just by way of example, the URI “http://www.sample.com” may be identified in the email message. For example, such exemplary URI may be identified by matching the predefined format of Table 1 with the URI in the email message. Once identified, the URI may be extracted from the email message, as described above. It should be noted that while a URI is described with respect to the present, embodiment, any desired type of link via which an image may be loaded may be identified in the email message.

Additionally, the URI extractor 402 may send the extracted URI to the URI extraction library 404. The URI extraction library 404 may process the URI upon receipt thereof. As an option, the URI may be normalized utilizing the URI extraction library 404, Normalizing the URI may include changing the URI from a first format to a second format. For example, the normalizing may remove any obfuscation of the URI.

In one embodiment, normalizing the URI may include adding any missing forward slash (“/”) characters. In another embodiment, normalizing the URI may include decoding various portions of the URI. For example, the portions that may be decoded may include encoded American Standard Code for Information Interchange (ASCII) characters, encoded octets within an internet protocol (IP) based URI, an IP based URI with an IP address represented as a single unsigned long hexadecimal or a single unsigned long decimal value, etc. In yet another embodiment, the URI may be normalized by removing hypertext transfer protocol (HTTP) redirectors from the URI.

Further, the normalized URI is sent from the URI extraction library 404 to a decision support system 406. The decision support system 406 may determine whether the URI includes a known unwanted URI, in one embodiment. For example, the decision support system 406 may compare the URI to a database of known URIs 408 for determining whether the email message is unwanted based on the comparison.

As an option, the database of known URIs 408 may include a whitelist database. Just by way of example, the whitelist database may include a list of URIs predetermined to be associated with known wanted data (e.g. data that does not necessarily include solicitations, malware, etc.). Thus, if the decision support system 406 identifies a match between the URI received from the URI extraction library 404 and a URI included in the whitelist database, the decision support system 406 may determine that the URI is wanted, and thus that the email message including the URI is wanted.

As another option, the database of known URIs 408 may include a blacklist database. Just by way of example, the blacklist database may include a list of URIs predetermined to be associated with known unwanted data (e.g. unsolicited data, such as spam, phish, etc.). Thus, if the decision support system 406 identifies a match between the URI received from the URI extraction library 404 and a URI included in the blacklist database, the decision support system 406 may determine that the URI is unwanted, and thus that the email message including the URI is unwanted.

By comparing the URI with the database, further processing of the URI may be prevented. For example, further processing of the URI by the system 400 (as described in detail below) may be prevented if the decision support system 406 identified the email message is wanted or unwanted. Preventing such further processing may limit resource consumption otherwise associated with the processing.

However, if the decision support system 406 is unable to determine whether the email message is unwanted based on the comparison of the URI with the database of known URIs (e.g. if the URI does not match a URI included in such database), the decision support system 406 may send the URI to a URI loader 410. The URI loader 410 may load the URI upon receipt thereof. Loading the URI may result in loading of an image associated with the URI, with respect to the present embodiment.

Just by way of example, once the URI is loaded (e.g. in a web browser, etc.), a handler of a web page opened by the URI may be returned. In addition, any images located on such web page may also be loaded. As an option, if the loaded. URI includes other links to other data (e.g. links to albums, folders, etc.), such, other data may also be loaded. Accordingly, a handler of another web page opened by such other links may be returned, along with any images located on such other web page. In this way, any images either directly or indirectly associated with the URI may optionally be loaded.

Further, the URI loader 410 may extract any of the loaded images. For example, the URI loader 410 may extract a loaded image from the loaded web pages. To this end, the images may be sent to an image analyzer 412 for analyzing the images.

In one embodiment, the image analyzer 412 may generate a signature corresponding to at least one of the images received from the URI loader 410. The signature may be generated utilizing any desired algorithm. For example, the signature may include a checksum of the image.

In addition, the image analyzer 412 may compare each of the signatures to a database of known signatures 414. The database of known signatures 414 may include a whitelist database, in one embodiment. For example, the whitelist database may store signatures of images predetermined to be wanted. Thus, if each of the signatures generated for the images match one of the signatures in the whitelist database, it may be determined that the images are wanted, and thus that the email message is wanted.

In another embodiment, the database of known signatures 414 may include a blacklist database, in one embodiment. For example, the blacklist database may store signatures of images predetermined to be unwanted. Thus, if any of the signatures generated for the images match one of the signatures in the blacklist database, it may be determined that the associated image is unwanted, and thus that the email message is unwanted.

In another embodiment, the image analyzer 412 may process each image received from the URI loader 410 for determining whether the email message is unwanted. As an option, such processing and determination may be conditionally performed based on results of the comparison of the signature of the image with the database of known signatures 414. For example, only if the signature of the image does not match one of the signatures in such database 414, the image analyzer 412 may process each image for determining whether the email message is unwanted.

As another option, the processing by the image analyzer 412 and the determination of whether the email message is unwanted based on such processing may be conditionally performed based on results of the comparison of the URI to the database of known URIs 408 determined by the decision support system 406. For example, as described above, only if the URI does not match one of the known URIs in the database of known URIs 408, the image analyzer 412 may process each image for determining whether the email message is unwanted.

In one embodiment, the image analyzer 412 may process an image received by the URI loader 410 by extracting information from the image. In various embodiments, the information may include a file name (e.g. retrieved from a message portion of headers associated with the image), a checksum of the image [e.g. determined utilizing the secure hash algorithm-1 (SHA-1), etc.], a size of the image, an indication of whether all lines of the image are of the same length, a length value (e.g. bytes) associated with the image (e.g. a length of a shortest line of the image, a length of a longest line of the image, etc.), etc.

In other embodiments, if the image includes a portable network graphics (PNG) or GIF image, other various information may be extracted from the image. For example, the information may include an identifier of a type of the image (e.g. GIF87a, GIF89a, etc.), a value in pixels of a width of the image, a value in pixels of a height of the image, an area in pixels of the image, etc. Further, if the image includes a GIF image a bit depth of a global color table (GCT) used by the image may be extracted, a size of the global color table may be extracted, an aspect ratio of pixels of the image may be extracted, etc. Moreover, if the image includes a PNG image a color type of the image may be extracted, a compression method used to compress the image may be extracted, a filter method used to filter the image may be extracted, an interlace method associated with the image may be extracted, etc.

In another embodiment, the image analyzer 412 may process the image received by the URI loader 410 by scoring the image. For example, the information extracted from the image may be weighted for determining a score for the image. As an option, the weights may be assigned to each portion of information extracted from the image, based on preconfigured rules. Just by way of example, a weight of “1” may be assigned to a checksum of the image if the checksum of the image matches a predetermined checksum preconfigured to be associated with the weight of “1”. As a further option, the weights assigned to each portion of information extracted from the image may be combined for determining a score for the image. Of course, it should be noted that the image analyzer 412 may determine a score for the image in any desired manner.

Still yet, the image analyzer 412 may determine whether the email message is unwanted, based on the processing of each of the images. In one embodiment, the image analyzer 412 may compare the score of each of the images to a predefined threshold. If the score of any of the images meets the predefined threshold, the email message may be determined to be unwanted. If however, the score of each of the images does not meet the threshold, the email message may be determined to be wanted.

As an option, the image analyzer 412 may further react based on such determination of whether the email message is unwanted. The reaction may include quarantining the email message (e.g. if the email message is determined to be unwanted), deleting the email message (e.g. if the email message is determined to be unwanted), categorizing the email message (e.g. as wanted or unwanted), reporting the email message (e.g. as wanted or unwanted), allowing the email message to be communicated (e.g. if the email message is determined to be wanted), etc.

As yet another option, if it is determined that a score of an image exceeds the predefined threshold, the reaction may include storing the signature of such image in a blacklist database, such as the database of known signatures 414 and/or storing the URI associated with such image in a blacklist database, such as the database of known URIs 408. As still yet another option, if it is determined that a score of an image does not exceed the predefined threshold, the reaction may include storing the signature of such image in a whitelist database, such as the database of known signatures 414 and/or storing the URI associated with such image in a whitelist database, such as the database of known URIs 408. In this way, subsequent identifications of the URI associated with such image in an email message may allow the email message to be identified as wanted or unwanted utilizing databases 408 and/or 414, thus preventing repeated processing of the image by the image analyzer 412.

In one exemplary embodiment, an email message with the URI “http://picasaweb.google.com/arun.sams” may be identified. Additionally, the URI extractor 402 may identify such URI in the email. Based on the identification of the URI, the URI extractor 402 may send the URI to the URI extraction library 404.

The URI extraction library 404 may analyze the URI and determine whether the URI is to be normalized. For example, in one embodiment, the URI extraction library 404 may determine that the URI is not to be normalized, as the format already includes a predetermined format. Thus, the URI is sent to the decision support system 406.

The decision support system 406 compares the URI with the database of know URIs 408. With respect to the present exemplary embodiment, the URI may include a legitimate free photo sharing website. Thus, the decision support system 406 may determine that the URI is not necessarily known to be unwanted.

To this end, the decision support system 406 may send the URI to the URI loader 410. The URI loader may open the web page linked to by the URI. If there is an album and/or folder present in such web page, such album and/or folder may be opened and 5 images may be extracted, one at a time. The extracted images are sent to the image analyzer 412, and an array of image data (e.g. checksum, name, size, x and y coordinates, bit depth and GCT) is extracted for each image.

Each portion of image data is weighted, based on rules. Table 2 shows various rules that may be utilized to weight the image data. It should, be noted that such rules are set forth for illustrative purposes only, and thus should not be construed as limiting in any manner.

TABLE 2

| | |
|---|---|
| 1. | If the checksum matches |

“xism:348d12a96f137a037e2d5d26de87a974cd593386” assign score 1

| | |
|---|---|
| 2. | If the name of the image matches “-xism: GIF87a” assign score 1 |
| 3. | If the color type matches “-xism:image” assign score 1 or |
| 4. | If the color matches “-xism:image/jpeg” assign score 1 or |
| 5. | If the bit depth matches “-xism:1” assign score 1 or |
| 6. | If the x matches “-xism:421” assign score 1 |

A total score is calculated for each image, based on the weights associated with the image data for the image. Furthermore, the total scores for each of the images is combined for determining a collective score for the email message. If the collective score exceeds a threshold (e.g. 10), the email message is determined to be unwanted, and is optionally flagged as unwanted.

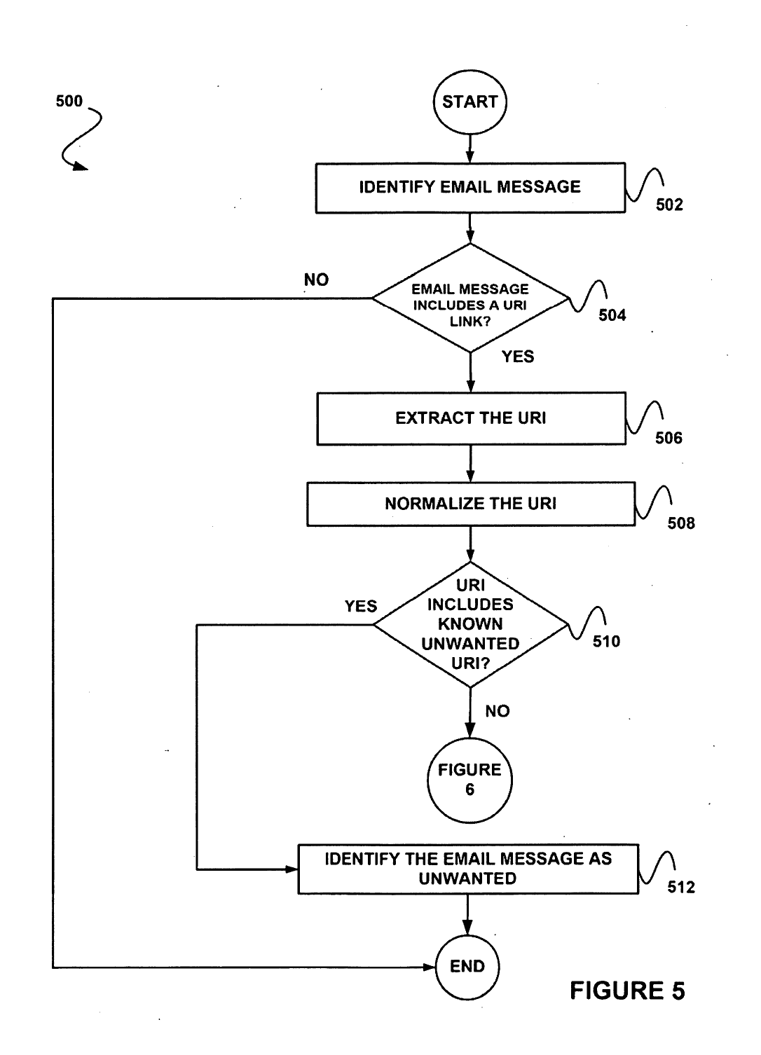

FIG. 5 shows a method 500 for identifying an electronic mail message as unwanted based on a determination of whether a uniform resource identifier (URI) link of the electronic mail message includes a known unwanted URI, in accordance with yet another embodiment. As an option, the method 500 may be carried out in the context of the architecture and environment of FIGS. 1-4. Of course, however, the method 500 may be carried out in any desired environment. Again, it should be noted that the aforementioned definitions may apply during the present description.

As shown in operation 502, an email message is identified. In one embodiment, the email message may be identified upon composition thereof. In another embodiment, the email message may be identified in response to receipt thereof by an intended recipient of the email message. In yet another embodiment, the email message may be identified in response to a request to send, the email message (e.g. over a network, etc.).

Additionally, it is determined whether the email message includes a URI link, as shown in decision 504. For example, content of the email message may be analyzed for determining whether the email message includes a URI link, it should be noted that while a URI is described with respect to the present embodiment, any desired type of link may be identified in the email message.

If it is determined that the email message does not include a URI link, the method 500 terminates. If, however, it is determined that the email message includes a URI link, the URI is extracted from the email message. Note operation 506. For example, a copy of the URI may be obtained.

Further, the URI is normalized, as shown in operation 508. It is then determined whether the URI includes a known unwanted URI. Note decision 510. As an option, the URI may he compared to a database of known unwanted URIs. Thus, if a match is detected, it may be determined that the URI includes a known unwanted URI.

If it is determined that the URI includes a known unwanted URI, the email message is identified as unwanted, as shown in operation 510. In one embodiment, a reaction may be performed if the email message is identified as unwanted. Thus, such reaction may be particular to the identification of the email message as unwanted.

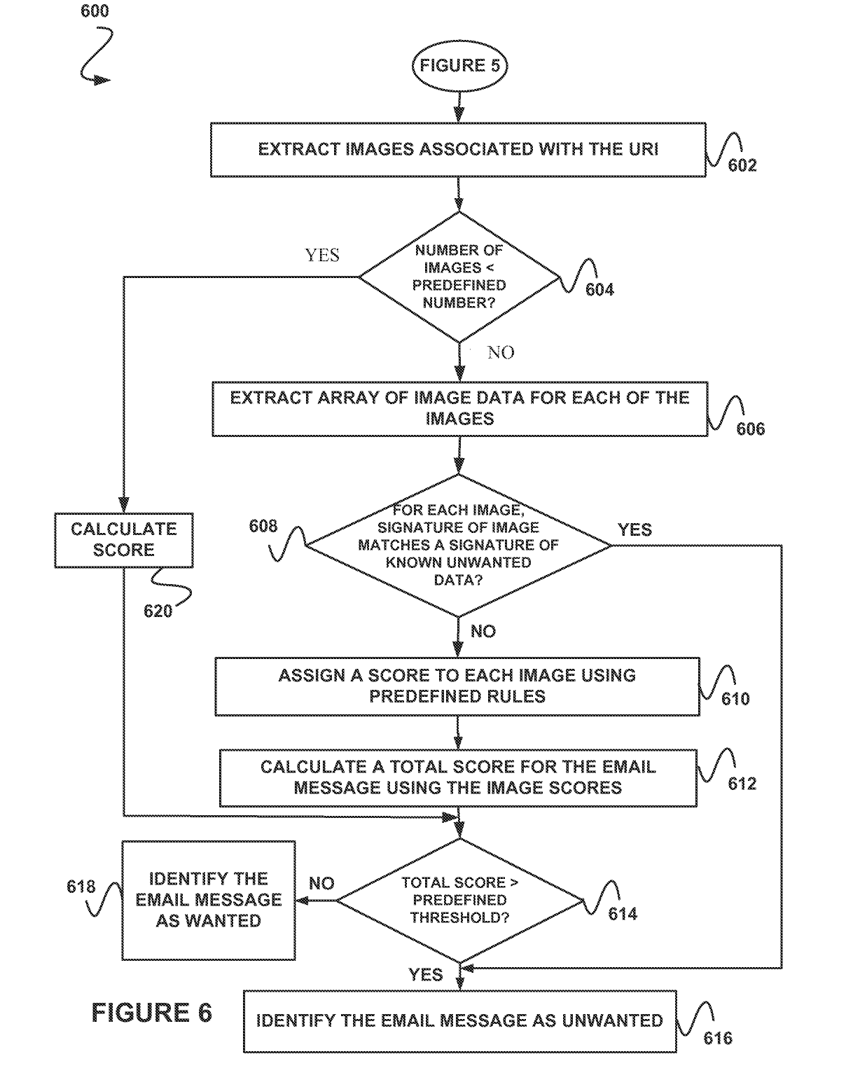

If, however, it is determined that the URI does not includes a known unwanted URI, the method 500 proceeds to the method 600 of FIG. 6. The method 600 of FIG. 6 may process images associated with a URI of an electronic mail message for determining whether the electronic mail message is unwanted, as described below.

Of course, while not shown, it may also be determined, whether the URI includes a known wanted URI, prior to proceeding to the method 600 of FIG. 6. For example, the URI may be compared to a database of known wanted URIs. Accordingly, if a match is detected, it may be determined that the URI includes a known wanted URI, and thus the method 500 may terminate without proceeding to the method 600 of FIG. 6, thus preventing further utilization of processing resources.

FIG. 6 shows a method 600 for processing images associated with a URI of an electronic mail message for determining whether the electronic mail message is unwanted, in accordance with still yet another embodiment. As an option, the method 500 may be carried out in the context of the architecture and environment of FIGS. 1-5. Of course, however, the method 500 may be carried out in any desired environment. Again, it should be noted that the aforementioned definitions may apply during the present description.

As shown in operation 602, images associated with a URI are extracted. In one embodiment, the images may be extracted by loading the URI. In another embodiment, the images may be extracted by loading the images.

Additionally, it is determined whether a number of the images is less than a predefined number (e.g. 5 images, etc.). Note decision 606. If the number of images is less than the predefined number, a score for each of the images may be calculated, as shown in operation 620. The score may be calculated in any desired manner. For example, the score may be calculated based on a number of the images.

If, however, it is determined that the number of images is not less than the predefined number, an array of image data for each of the images is extracted. Note operation 606. The array of image data may include any information associated with the images. With respect to the present embodiment, the information may include a signature of the image. In other optional embodiments, the information may include a size of the image, a checksum of the image, a signature of the image, etc.

Further, as shown in decision 608, it is determined for each image whether a signature of such image matches a signature of known unwanted data. For example, the signature of each of the images may be compared to signatures of known unwanted data Included in a database. If it is determined that any of the signatures of the images matches a signature of known unwanted data, the email message is identified as unwanted. Note operation 616.

If however, it is determined that none of the signatures of the images matches a signature of known unwanted data, a score is assigned to each image using predefined rules. Note operation 610. The score for an image may be calculated based on the array of image data extracted for such image (see operation 606), as an option. For example, a weight may be determined for each element of image data in the array, and a sum of the weights determined for each element in the array may be calculated for scoring the image.

Moreover, a total score for the email message is calculated using the image scores calculated in operation 610. Note operation 612. In one embodiment, the total score may be calculated by summing the scores of the images. Of course, however, the total score may be calculated in any manner that uses the scores of the images.

Still yet, once a score is calculated in operation 620 or in operation 612, it is determined whether such score is greater than a predefined, threshold. Note decision 614. Thus, the score may be compared to the predefined threshold. If it is determined that the score is greater than the predefined threshold, the email message is identified as unwanted (operation 616). If, however, it is determined that the score is not greater than the predefined threshold, the email message is identified as wanted. Note operation 618.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer program product embodied on a non-transitory computer readable medium comprising instructions stored thereon to cause one or more processors to:
identify a link in an electronic mail message;
load a plurality of images using the link;
process the plurality of images;
calculate an image score for each of the plurality of images, the image score based on attributes associated with each of the plurality of images, the attributes comprising at least one of a file name, a file size, a checksum, x and y coordinates, and a bit depth of a global color table (GCT);
calculate an overall score for the electronic mail message based on the calculated plurality of image scores; and
determine whether the electronic mail message is unwanted based on the overall score.

2. The computer program product of claim 1, wherein the link includes a uniform resource locator.

3. The computer program product of claim 1, further comprising instructions to cause one or more processors to normalize the link.

4. The computer program product of claim 1, further comprising instructions to cause one or more processors to compare the link to a database of known links and determine whether the electronic mail message is unwanted based on the comparison.

5. The computer program product of claim 4, wherein the database includes a whitelist database.

6. The computer program product of claim 4, wherein the database includes a blacklist database.

7. The computer program product of claim 4, further comprising instructions to cause one or more processors to conditionally perform the instructions to process the plurality of images and the instructions to determine whether the electronic mail message is unwanted based on the overall score based on results of the comparison.

8. The computer program product of claim 1, further comprising instructions to cause one or more processors to generate a signature corresponding to at least one image selected from the plurality of images.

9. The computer program product of claim 8, further comprising instructions to cause one or more processors to compare the signature to a database of known signatures.

10. The computer program product of claim 9, wherein the database includes a whitelist database.

11. The computer program product of claim 9, wherein the database includes a blacklist database.

12. The computer program product of claim 9, further comprising instructions to cause one or more processors to conditionally perform the instructions to process the plurality of images and the instructions to determine whether the electronic mail message is unwanted based on the overall score based on results of the comparison.

13-14. (canceled)

15. The computer program product of claim 13, further comprising instructions to cause one or more processors to compare each image score with a threshold.

16. The computer program product of claim 1, further comprising instructions to perform an action based on the determination of whether the electronic mail message is unwanted.

17. The computer program product of claim 16, wherein the action includes at least one of quarantining the electronic mail message, deleting the electronic mail message, categorizing the electronic mail message, and reporting the electronic mail message.

18. A method, comprising:
identifying a link in an electronic mail message;
loading a plurality of images using the link;
processing the plurality of images;
calculating an image score for each of the plurality of images, the image score based on attributes associated with each of the plurality of images, the attributes comprising at least one of a filename, a file size, a checksum, x and y coordinates, and a bit depth of a global color table (GCT);
calculating an overall score for the electronic mail messages based on the calculated plurality of image scores; and
determining whether the electronic mail message is unwanted based on the overall score.

19. A system, comprising: one or more processors configured to:
identify a link in an electronic mail message;
load a plurality of images using the link;
process the plurality of images;
calculate an image score for each of the plurality of images, the image score based on attributes associated with each of the plurality of images, the attributes comprising at least one of a filename, a file size, a checksum, x and y coordinates, and a bit depth of a global color table (GCT);
calculate an overall score for the electronic mail message based on the calculated plurality of image scores; and
determine whether the electronic mail message is unwanted based on the overall score.

20. (canceled)

21. A computer program product embodied on a non-transitory computer readable medium comprising instructions to cause one or more processors to:
load a plurality of images using a link in an electronic mail message;
process each of the plurality of images to determine at least one of a filename, a file size, a checksum, x and y coordinates, and a bit depth of a global color table (GCT);
calculate an overall score for the email message based on the processing; and
determine whether the electronic mail message is unwanted based on the overall score.

22. The computer program product of claim 21, further comprising instructions to cause one or more processors to generate a signature corresponding to at least one image selected from the plurality of images.

23. The computer program product of claim 22, further comprising instructions to cause one or more processors to compare the signature to a database of known signatures.

24. The computer program product of claim 23, wherein the database includes a whitelist database.

25. The computer program product of claim 23, wherein the database includes a blacklist database.

26. The computer program product of claim 23, further comprising instructions to cause one or more processors to conditionally perform the instructions to process the plurality of images and the instructions to determine whether the electronic message is unwanted based on results of the comparing.

27. The computer program product of claim 21, wherein the instructions to cause one or more processors to process the plurality of images comprise instructions to cause one or more processors to calculate an image score for each of the plurality of images.

28. The computer program product of claim 27, wherein the instructions to cause one or more processors to calculate an image score comprise instructions to calculate an image score based on information associated with the at least one image including at least one of a file name, a file signature, a file size, a checksum, x and y coordinates, and a bit depth of a GCT.

29. The computer program product of claim 27, further comprising instructions to cause one or more processors to compare the image score with a threshold.
